(19) United States
(12) Patent Application Publication
(10) Pub. No.: US 2024/0198246 A1
(43) Pub. Date: Jun. 20, 2024

(54) INTERACTIVE DOLL

(71) Applicant: Flycatcher Corp LTD, London (GB)

(72) Inventors: Shay CHEN, Neve Yarak (IL); Shachar LIMOR, Givat Shapira (IL)

(21) Appl. No.: 17/631,468

(22) PCT Filed: Jul. 27, 2020
(86) PCT No.: PCT/IB2020/057074

§ 371 Date: Nov. 13, 2023

Related U.S. Application Data
(60) Provisional application No. 62/880,295, filed on Jul. 30, 2019.

(51) Int. Cl. A63H 3/36; A63H 3/00; A63H 3/28; G09B 5/04

(52) U.S. Cl. CPC A63H 3/36; A63H 3/006; A63H 3/28; A63H 2200/00; G09B 5/04

(57) ABSTRACT

An interactive doll, including a doll body having decorative elements, and at least one output interface adapted to provide instructions and feedback to a user. A first sensor is adapted to identify at least one of motion of the doll, orientation of the doll, or acceleration of the doll, and a second sensor is adapted to identify at least one characteristic on a surface of the doll body. The doll includes at least one instruction repository storing a plurality of instructions and associated valid responses for responding to each instruction. A controller includes a processor and a medium storing instructions to be executed by the processor, including instructions to provide an instruction to the user, instructions to receive a response of the user to the instruction, instructions to identify if the response is a valid response to the instruction, and instructions to provide feedback to the user.

### FIELD AND BACKGROUND OF THE INVENTION

The invention, in some embodiments, relates to the field of electronic toys, and more specifically to an interactive doll which interacts with the child by providing to the child instructions and responding when the child fulfills the instructions.

Many electronic toys exist, where there are multiple buttons, and each button the child presses causes something to occur. For example, such toys exist for teaching children animal sounds, instrument sounds, and the like. However, one disadvantage of these toys is that each time the child presses a button, the result is always the same. After a short play-time, the child typically gets bored with the toy, because he already knows exactly what will happen when each button is pressed, and/or where he needs to press to provide the correct answer to a question asked by the toy.

Furthermore, electronic toys are typically used on a surface and are not moved around, and as such these toys typically do not teach relative terms, such as directions, high/low, and the like.

As such, there is a need in the art for an interactive electronic toy wherein play is less predictable and less sedentary, requiring the child to learn relative terms and continue learning even during extended play, and as a result keeping the child's attention for a longer time.

### SUMMARY OF THE INVENTION

The invention, in some embodiments, relates to the field of electronic toys, and more specifically to an interactive electronic doll which interacts with the child by providing to the child instructions and responding when the child fulfills the instructions.

In accordance with some embodiments of the invention, there is provided an interactive doll, including:
a doll body, including a plurality of decorative elements;
at least one output interface adapted to provide instructions and feedback to a user;
at least one sensor, adapted to identify interaction of the user with the doll;
at least one instruction repository storing a plurality of instructions, each instruction associated with at least one valid response for responding the instruction; and
a controller including:
   a processor functionally associated with the at least one output interface, the at least one sensor, and the at least one instruction repository; and
   a non-transitory computer readable storage medium storing software modules including instructions to be executed by the processor, the non-transitory computer readable storage medium having stored:
      instructions to provide an instruction from the at least one instruction repository to the user via the at least one output interface;
      instructions to receive, from the at least one sensor, at least one transmission indicative of a response of the user to the instruction;
      instructions to identify, based on the at least one transmission, if the response of the user is one of the at least one valid response to the instruction; and
      instructions to provide feedback to the user, via the at least one output interface, the feedback corresponding to the response of the user.

In some embodiments, the interactive doll further includes a plurality of illuminators disposed within the doll body. In some embodiments, at least one of the plurality of illuminators, and in some embodiments most of the plurality of illuminators, is associated with, and adapted to illuminate, one of the plurality of decorative elements.

In some embodiments, the output interface is an audio output interface, adapted to provide the instructions and the feedback audibly to the user.

In some embodiments, the at least one sensor includes a motion sensor, adapted to sense motion of the doll. In some embodiments, the at least one sensor includes an orientation sensor adapted to sense a three dimensional orientation of the doll. In some embodiments, the at least one sensor includes an acceleration sensor adapted to sense acceleration of the doll. In some embodiments, the at least one sensor includes a location sensor adapted to sense a location of the doll.

In some embodiments, the at least one sensor includes at least one pressure sensor, adapted to sense whether pressure is applied to the doll or to one of the plurality of decorative elements. In some embodiments, the at least one sensor includes at least one temperature sensor, adapted to sense a temperature in a vicinity of the doll or of one of the plurality of decorative elements. In some embodiments, the at least one sensor includes at least one light sensor, adapted to sense illumination in a vicinity of the doll or of one of the plurality of decorative elements. In some embodiments, the at least one sensor includes at least one color sensor, adapted to sense a color in a vicinity of the doll or of one of the plurality of decorative elements.

In some embodiments, the doll is devoid of a mechanism for communicating with another electronic device.

In some embodiments, the instructions to provide feedback include:
instructions, to be executed responsive to the response being one of the at least one valid response, to provide reinforcing feedback to the user; and
instructions, to be executed responsive to the response not being one of the at least one valid response, to provide corrective feedback to the user.

There is further provided, in accordance with another embodiment of the present invention, a method for interacting with a user using an interactive doll, the interactive doll including a doll body having a plurality of decorative elements, the method including:
providing to the user an instruction from an instruction repository, via an output interface forming part of the interactive doll;
receiving from at least one sensor forming part of the doll, at least one transmission indicative of a response of the user to the instruction;
identifying, based on at least one transmission from at least one sensor forming part of the interactive doll, whether the response of the user to the instruction is a valid response to the instruction; and
based on the identifying, providing feedback to the user, via the at least out output interface.

In some embodiments, providing feedback includes, in response to the identifying that the response of the user is a valid response to the instruction, providing a reinforcing feedback to the user.

In some embodiments, providing feedback includes, in response to the identifying that the response of the user is not a valid response to the instruction, providing a corrective feedback to the user.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted in the figures are not to scale.

In the Figures:

FIGS. 1A and 1B are, respectively, top and bottom view perspective illustrations of an interactive doll according to an embodiment of the teachings herein;

FIGS. 2A, 2B, 2C, and 2D are, respectively, front, top, back, and side plan view illustrations of another interactive doll, similar to the interactive doll of FIGS. 1A and 1B;

FIGS. 3A and 3B are, respectively, front and back view perspective illustrations of yet another interactive doll according to an embodiment of the teachings herein;

FIG. 4 is a schematic block diagram of an interactive doll according to embodiments of the teachings herein; and

FIG. 5 is a flowchart of an embodiment of an exemplary method of using the interactive dolls of FIGS. 1 to 4.

### DESCRIPTION OF SOME EMBODIMENTS OF THE INVENTION

The invention, in some embodiments, relates to the field of electronic toys, and more specifically to an interactive doll which interacts with the child by providing to the child instructions and responding when the child fulfills the instructions.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

The doll and method described herein are intended to provide an interactive environment in which a user, typically a child, plays with a doll and moves it around in accordance with instructions provided by the doll. Sensors within the doll sense the actions taken by the child and react to the child playing. Each time the child activates the doll, different instructions are provided to the child, selected at random from a set of available instructions, and instructions from a predetermined set of responses is provided in response to the child's actions.

For example, the interactive doll may be an airplane shaped doll, which, when activated, says to the child “I want to fly high today!”. As the child moves the doll and makes the doll fly higher, the doll responds and says “wow! That is great! I am high now!”. Alternatively, if the child moves the doll along the floor, the doll may respond and say “We are flying low today. I really want to fly high!”. Additional examples are provided hereinbelow.

It is appreciated that because a doll is a toy that is typically moved around, and not held flat on a surface, the doll of the present invention is conducive to teaching children about relative terms, such as high, low, in front, behind, on, and the like, as well as about directions.

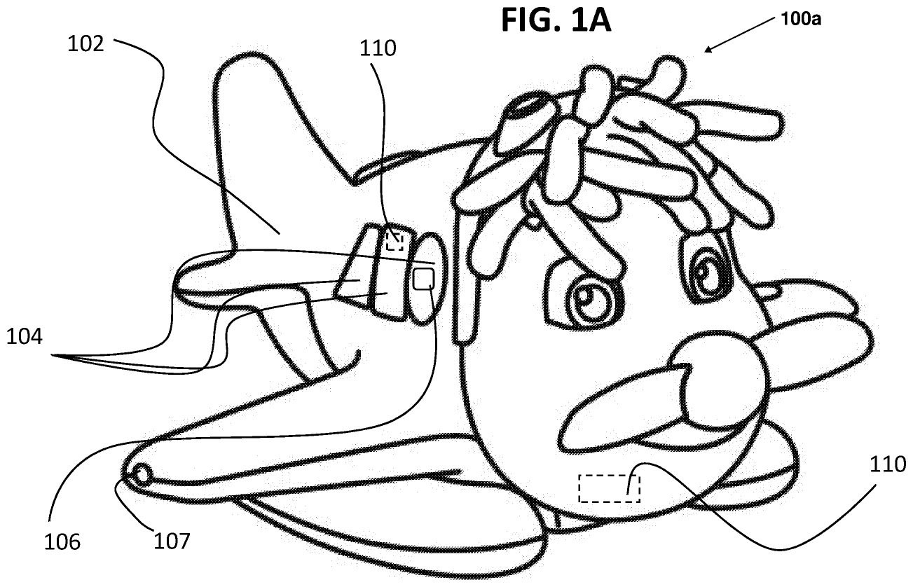

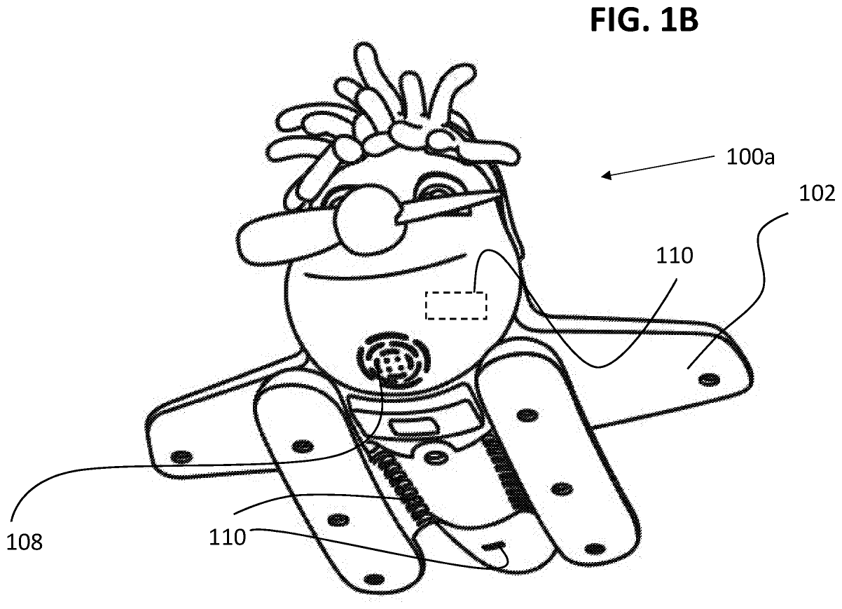

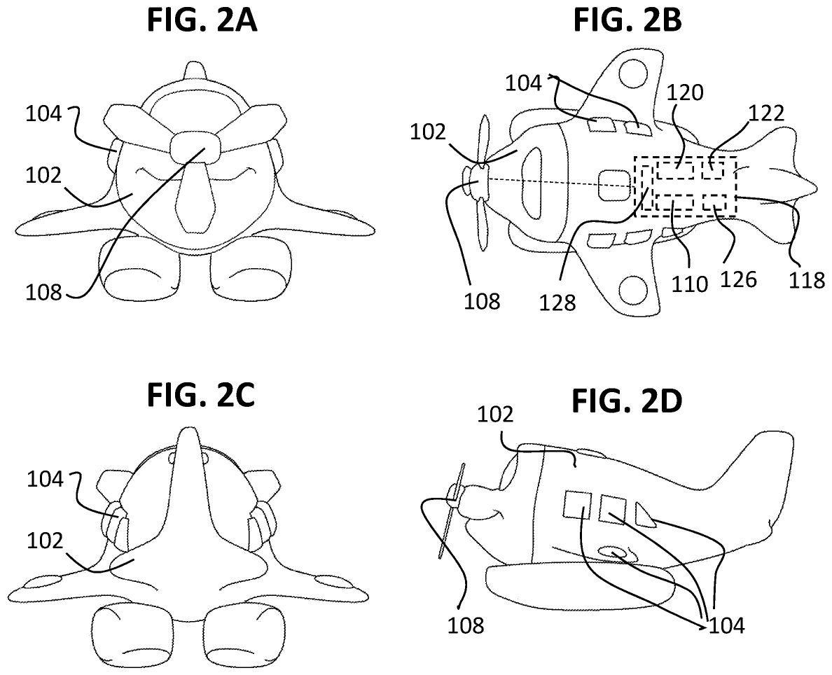

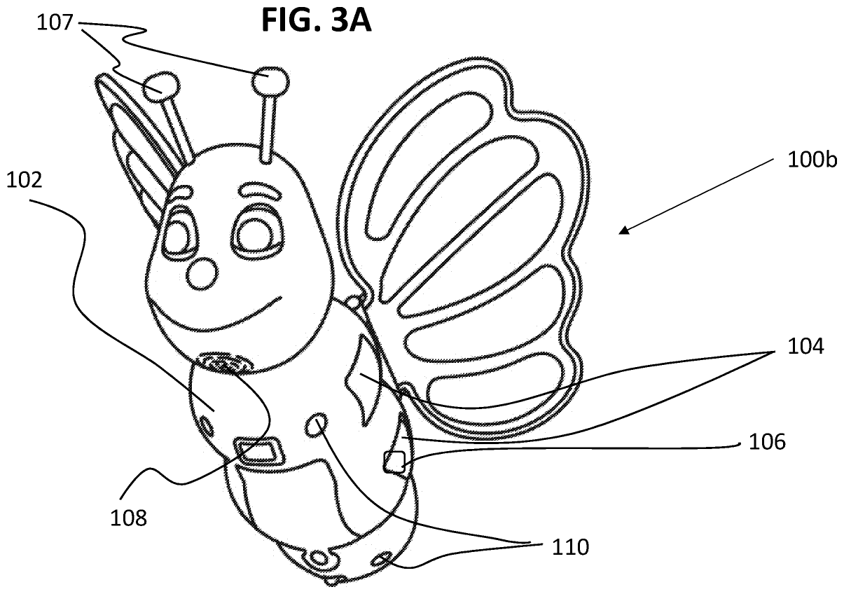

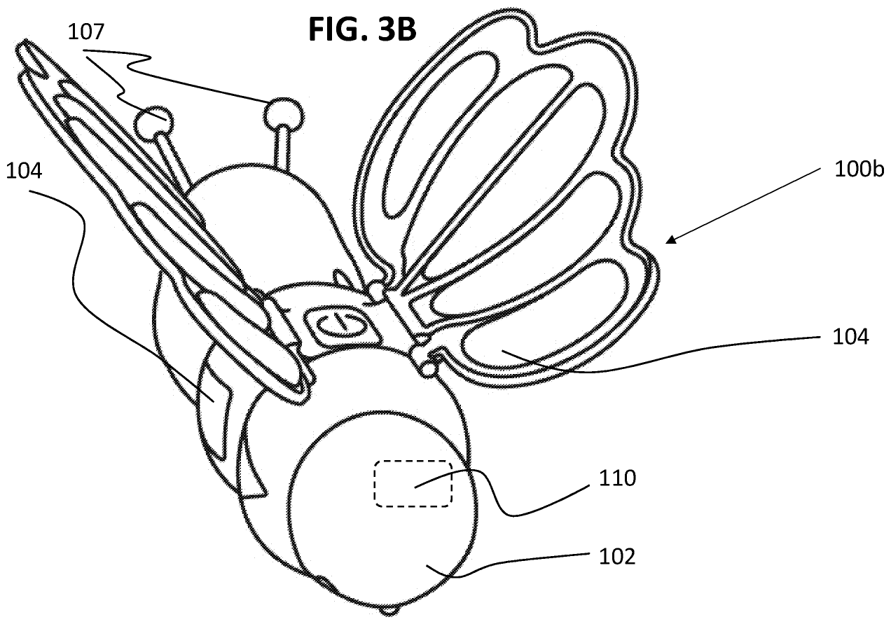

Reference is now made to FIGS. 1A and 1B which are, respectively, top and bottom view perspective illustrations of an interactive doll 100a according to an embodiment of the teachings herein, and to FIGS. 2A, 2B, 2C, and 2D which are, respectively, front, top, back, and side plan view illustrations of another interactive doll, similar to interactive doll 100a of FIGS. 1A and 1B.

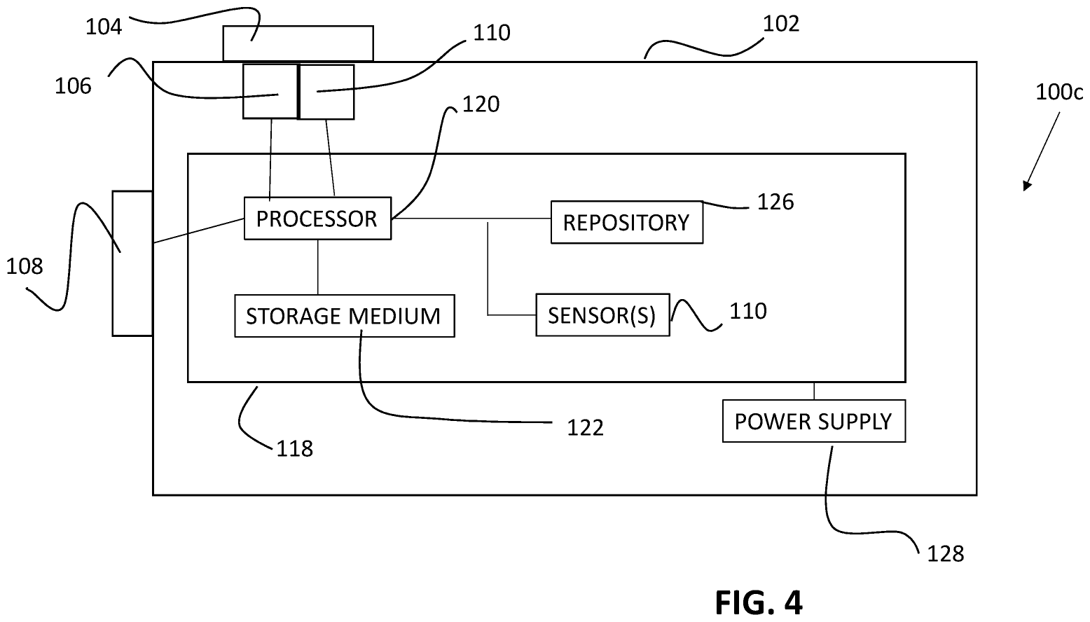

Reference is additionally made to FIGS. 3A and 3B are, respectively, front and back view perspective illustrations of another interactive doll 100b according to an embodiment of the teachings herein, and to FIG. 4, which is a schematic block diagram of an interactive doll 100c according to embodiments of the teachings herein.

As seen in FIGS. 1 to 4, interactive dolls 100a, 100b, and 100c each include a doll body 102. The doll body 102 is in a shape that is attractive for children to play with. For example, body 102 of doll 100a is shaped like an airplane, and body 102 of doll 100b is shaped like a butterfly. Additional possible shapes include, but are not limited to, shapes of animals, shapes of vehicles, shapes of characters such as knights, princesses, fairies and the like, or any other suitable shape.

Typically, doll body 102 is rigid, and may be formed of a rigid and hollow material, such as a plastic material or a rigid polymer. However, in other embodiments, the doll body may be deformable, for example formed of fabric filled with fiberfill or formed of a compressible polymer. In some such embodiments, the doll may be a plush doll.

Doll body 102 has formed on an exterior surface thereof a plurality of decorative elements 104. In some embodiments, such as those illustrated in FIGS. 1A to 3B, each of the decorative elements 104 may have a different shape and/or a different color.

As seen clearly in FIG. 4, in some embodiments, each of the decorative elements 104 is associated with a corresponding illuminator 106, which may illuminate the corresponding decorative element 104. In some embodiments, the different colors of the decorative elements 104 are a result of colored illumination emanating from corresponding illuminator 106. In such embodiments, each specific decorative element 104 may have different colors at different times.

In some embodiments, the doll may have additional illuminators 107, such as LEDs. Illuminators 107 may be disposed at respective right and left sides of the doll, and may be used as direction indicators to the right and to the left, for example to hint to the child when it the instruction relates to a direction of motion.

Doll body 102 further includes at least one audio speaker 108, for example illustrated in FIG. 4. Audio speaker 108 is adapted to provide audio instructions and audio feedback, or responses, to the user, as explained in further detail hereinbelow.

Disposed within doll body 102 are one or more sensors 110 adapted to sense how the user plays with the doll.

In some embodiments, the one or more sensors 110 include a motion sensor adapted sense motion of the doll. In some embodiments, the one or more sensors 110 include a three-dimensional orientation sensor adapted to sense the orientation of the doll, for example, whether it is being rolled over or held vertically. In some embodiments, the one or more sensors 110 include an acceleration sensor adapted to sense acceleration of the doll. In some embodiments, the one or more sensors 110 include a location sensor, adapted to sense a location of the doll, for example a height of the doll above the ground.

In some embodiments, the one or more sensors 110 include a pressure sensor, adapted to sense whether pressure is applied to the doll or to a portion thereof. For example, a pressure sensor may sense that the body of the doll is being hugged very tightly by a child. As another example, a pressure sensor associated with a decorative element 104 may sense that the child is touching, or pressing on, the corresponding decorative element.

In some embodiments, the one or more sensors 110 include a temperature sensor, adapted to sense the temperature in a vicinity of the doll or a temperature of the doll or of a portion thereof. For example, a temperature sensor associated with a decorative element 104 may sense that the child is touching the corresponding decorative element by sensing that the decorative element is at a temperature corresponding to that of a human hand.

In some embodiments, the one or more sensors 110 include a light sensor and/or a color sensor, adapted to sense the illumination and/or color in a vicinity of the doll or of a portion thereof. For example, a light sensor associated with a decorative element 104 may sense that the child is touching the corresponding decorative element by sensing that the illumination received by the sensor behind the decorative element is decreased. As another example, a color sensor disposed on a bottom surface of the doll may identify that the doll is placed on an object of a specific color.

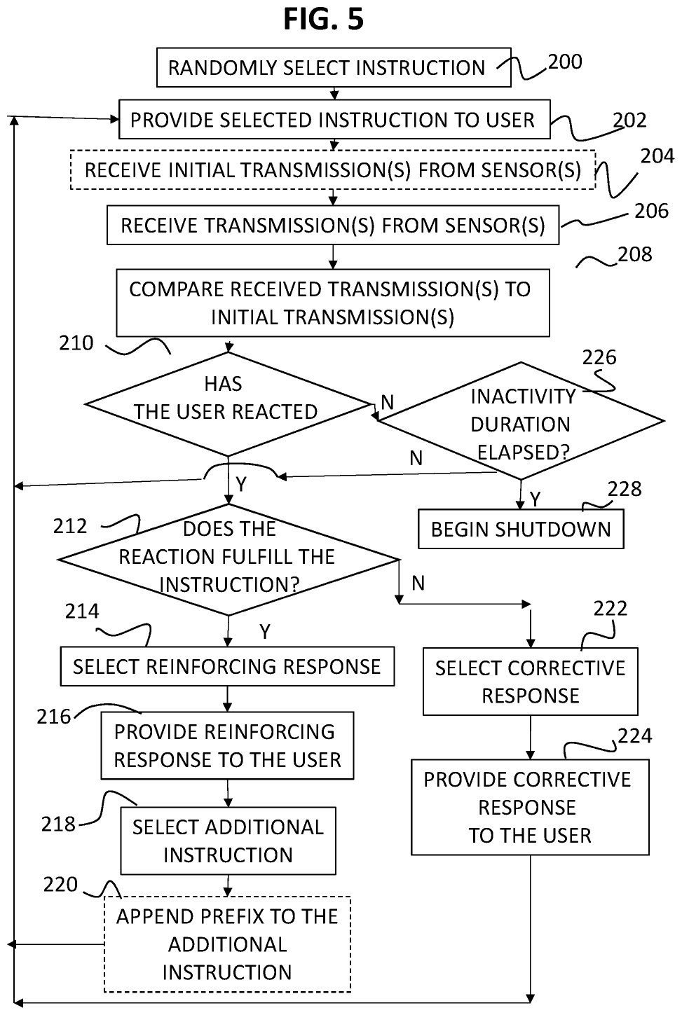

An electronic circuit 118 is disposed within a hollow in doll body 102, and may have at least some of the one or more sensors 110 disposed thereon. Electronic circuit 118 connects audio speaker(s) 108 and one or more sensors 110 to a processor 120, shown clearly in FIG. 4, which may be mounted onto electronic circuit 118 or onto a dedicated printed circuit board (not explicitly shown). Processor 120 is adapted to control operation of dolls 100a, 100b, and 100c, as explained in further detail hereinbelow with respect to FIG. 5.

Processor 120 is functionally associated with a non-transitory computer readable storage medium 122, shown clearly in FIG. 4, storing software modules including instructions to be executed by the processor 120. Storage medium 122 may be disposed on electronic circuit 118, on a separate printed circuit board also holding processor 120, or on a dedicated printed circuit board (not explicitly shown).

Processor 120 is further associated with a repository 126 storing a collection of audio instructions to be provided to the user. Each instruction stored in repository 126 is associated with one or more suitable responses for responding to the instruction, as explained in further detail hereinbelow. Repository 126 may be any suitable storage element for storing digital data, such as a database, a computer memory, or a buffering memory.

In some embodiments, the repository 126 is adapted to store, at least temporarily, large amounts of data, in the range of 0.5 MB to 200 MB. The repository 126 may be volatile or non-volatile memory, such as a flash memory device, retaining the stored data, even when the power is switched off and on, thus accelerating the device start up time.

One or more power supplies 128 are adapted to provide power to the doll and to components thereof, including audio speaker(s) 108, illuminator(s) 106, sensor(s) 110, processor 120 and/or repository 126. Power supply 128 may be any suitable power supply, such as a battery or a rechargeable battery, for example chargeable via a suitable port. Dolls 100a, 100b, and 100c are designed to be operable without connection to an external power source, or at a distance greater than 1 meter from an external power source, for extended durations of time, in the range of 1-4 hours of non-stop operation.

In some embodiments, interactive dolls 100a, 100b, and 100c may further include an inactivity sensing functionality adapted to identify when the doll has been inactive for a predetermined duration, and to provide such information to processor 120 for adapting operation of the doll so as to preserve power consumption by the doll when it is inactive.

In some embodiments, in response to detection of inactivity by the inactivity sensing functionality, processor 120 may run a low power efficiency power scheme adapted to conserve power in the doll, and/or may provide an audio indication to the user that the doll has been inactive and its electronic components are shutting down.

In some embodiments, interactive dolls 100a, 100b, and 100c may further include a thermal sensor, adapted to provide input to processor 120 when a temperature level in the doll exceeds a predetermined threshold. The processor 120 may then operate a temperature control module to adjust the operation of the doll to the elevated temperature level, for example by shutting down the electronic components of the doll, or by notifying the user of the elevated temperature, thereby to provide for safe and robust device operation.

Typically, interactive dolls 100a, 100b, and 100c are devoid of a mechanism for communicating with other electronic devices, such as by electromagnetic communication or radio frequency communication.

Reference is now additionally made to FIG. 5, which is a flowchart of an embodiment of an exemplary method of using the interactive dolls of FIGS. 1 to 4.

As seen in FIG. 5, at step 200 when the toy is activated or at some point thereafter, processor 120 executes instructions stored in storage medium 122 to randomly select a specific instruction from repository 126.

The instruction is typically an instruction for a way the child should play with the doll, and is often phrased using playful and friendly words. In some embodiments, the instruction may include any one or more of the following types of instructions:
Instructions to move the doll in a specific direction. Such instructions may include, for example, “I want to go left now!”, “Let's go up, up and away!”, “Uh oh, we need to back up!”.
Instructions to identify a specific shape. Such instructions may include, for example, “My square is itchy, please scratch it for me”, “Press my triangle, it is magic!” and the like.
Instructions to identify a specific color. Such instructions may include, for example, “My red decoration is itchy, please scratch it for me”, “Press my blue light, it is magic!”, “I want to land on something green today” and the like.
Instructions relating to characteristics of motion of the doll. Such instructions may include, for example, “Today I want to go for a slow stroll”, “I feel really jumpy now!”, “Lets go super fast!”, and the like.

The selected instruction is provided to the user audibly, via audio speaker(s) 108, at step 202, for example by processor 120 executing corresponding instructions stored in storage medium 122.

In some embodiments, at step 204, processor 120 receives initial transmissions of sensed readings from sensor(s) 110 at the time of providing the instruction to the subject, for example by processor 120 executing corresponding instructions stored in storage medium 122. The initial transmissions may be used as a baseline sensor reading for the doll.

Following providing of the instructions to the user, at step 206 processor 120 receives additional transmissions from sensor(s) 110, for example by processor 120 executing corresponding instructions stored in storage medium 122. The received additional transmissions provide information regarding the child's response to the instruction.

At step 208, the processor compares the additional received transmissions and the initial transmissions, or otherwise analyzes the additional received transmissions, and at step 210 uses the comparison to determine whether the child reacted to the instructions. This may be carried out by processor 120 executing corresponding instructions stored in storage medium 122. When the additional received transmissions are different from the initial transmissions, this is indicative that the child changed something about the doll in response to receipt of the instructions. The change may include moving the doll in a specific direction, changing the orientation of the doll, placing the doll at a specific location, or touching a specific portion of the doll. By contrast, when the comparison shows that the additional received transmissions are identical to the initial transmissions, this indicates that the user did not react to the instructions in any way.

As seen at step 212, when at step 210 it is determined that the child responded to the received instruction, processor 120 continues to analyze the received transmissions to determine whether the child's reaction was in accordance with the instructions, for example by processor 120 executing corresponding instructions stored in storage medium 122.

For example, if the instruction provided to the child was “Let's fly low so we can talk to our friends on the ground”, and the sensor signals child raised the doll plane of FIG. 1 four inches above the ground, processor 120 may conclude that the child fulfilled the instruction. Alternately, if, in the same situation, the child raised the doll of FIG. 1 three feet above the ground, or did not raise the doll from the ground at all but rather reacted by pressing on one of decorative elements 104, processor 120 may conclude that the child did not fulfill the instruction.

If it is determined at step 212 that the child fulfilled the instruction, then at step 214, processor 120 selects from repository 126 a reinforcing response associated with the instruction, and provides that reinforcing response audibly to the child, via speaker(s) 108 at step 216. Steps 214 and 216 may be accomplished, for example, by processor 120 executing corresponding instructions stored in storage medium 122.

Returning to the example provided above, when the child moved the airplane doll at a height of four inches above the ground, the processor may select the response “Wow! This is great! I see so many friends!” from the repository, and provide it audibly to the user.

In some embodiments, following providing of the reinforcing response, at step 218 the processor selects an additional instruction for providing to the user. Returning to the previous example, the processor may select the instruction “Let's turn right and explore!”.

In some embodiments, at optional step 220 the processor may append a prefix to the selected additional instruction, indicating that this is not the first instruction. In the current example, the prefix may be “now that we have done that”, such that the resulting additional instruction would be “Now that we have done that, let's turn right and explore!”.

Once the additional instruction is selected, flow returns to step 202, for providing the additional instruction to the user.

Returning to step 212, if it is determined that the child has not fulfilled the instruction, then at step 222, processor 120 selects from repository 126 a corrective response associated with the instruction, and provides that corrective response audibly to the child, via speaker(s) 108 at step 224. Steps 222 and 224 may be accomplished, for example, by processor 120 executing corresponding instructions stored in storage medium 122.

Returning to the example provided above, if the child moved the airplane doll at a height of three feet above the ground, the processor may select the response “This is too high! I can't see my friends from here!” from the repository, and provide it audibly to the user.

Alternately, if the child did not move the airplane doll but rather reacted by pressing on one of decorative elements 104, the processor may select the response “Come on! Let's move!” from the repository, and provide it audibly to the user.

In some embodiments, following providing of the corrective response, flow may return to step 202, for repeating the provision of the instruction to the user.

Returning to step 210, if it is determined that the child did not respond to the instruction at all, processor 120 may check whether the inactivity sensing functionality has identified inactivity of the doll for a predetermined duration at step 226. If such inactivity is identified, processor 120 may initiate shutdown or power reduction processes, as known in the art, at step 228. Otherwise, if the predetermined duration of inactivity has not passed, flow may return to step 202, for repeating the provision of the instruction to the user.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification, are herein incorporated in their entirety by reference into the specification, to the same extent as if each indi-vidual publication, patent or patent application was specifically and individually indicated to be incorporated herein by reference. In addition, citation or identification of any reference in this application shall not be construed as an admission that such reference is available as prior art to the present invention.

1. An interactive doll, comprising:
a doll body, including a plurality of decorative elements;
at least one output interface adapted to provide instructions and feedback to a user;
a first sensor, adapted to identify at least one of motion of the doll, orientation of the doll, or acceleration of the doll;
a second sensor, adapted to identify at least one characteristic on, or in the vicinity of, a surface of said doll body;
at least one instruction repository storing a plurality of instructions, each instruction associated with at least one valid response for responding to said instruction; and
a controller including:
a processor functionally associated with said at least one output interface, said at least one sensor, and said at least one instruction repository; and
a non-transitory computer readable storage medium storing software modules including instructions to be executed by said processor, said non-transitory computer readable storage medium having stored:
instructions to provide an instruction from said at least one instruction repository to the user via said at least one output interface;
instructions to receive, from said at least one sensor, at least one transmission indicative of a response of said user to said instruction;
instructions to identify, based on said at least one transmission, if said response of said user is one of said at least one valid response to said instruction; and
instructions to provide feedback to the user, via said at least one output interface, said feedback corresponding to said response of said user.

2. The interactive doll of claim 1, further comprising a plurality of illuminators disposed within said doll body, at least one of said plurality of illuminators being associated with, and adapted to illuminate, at least one of said plurality of decorative elements.

3. The interactive doll of claim 1, wherein said output interface is an audio output interface, adapted to provide said instructions and said feedback audibly to said user.

4. The interactive doll of claim 1, wherein said first sensor comprises a motion sensor, adapted to sense motion of said doll.

5. The interactive doll of claim 1, wherein said first sensor comprises an orientation sensor adapted to sense a three dimensional orientation of said doll.

6. The interactive doll of claim 1, wherein said first sensor comprises an acceleration sensor adapted to sense acceleration of said doll.

7. The interactive doll of claim 1, wherein said first sensor comprises a location sensor adapted to sense a location of said doll.

8. The interactive doll of claim 1, wherein said second sensor comprises a pressure sensor, adapted to sense whether pressure is applied to said doll or to one of said plurality of decorative elements.

9. The interactive doll of claim 1, wherein said second sensor comprises a temperature sensor, adapted to sense a temperature in a vicinity of said doll or of one of said plurality of decorative elements.

10. The interactive doll of claim 1, wherein said second sensor comprises a light sensor, adapted to sense illumination in a vicinity of said doll or of one of said plurality of decorative elements.

11. The interactive doll of claim 1, wherein said second sensor comprises a color sensor, adapted to sense a color in a vicinity of said doll or of one of said plurality of decorative elements.

12. The interactive doll of claim 1, wherein said doll is devoid of a mechanism for communicating with another electronic device.

13. The interactive doll of claim 1, wherein said instructions to provide feedback include:
instructions, to be executed responsive to said response being one of said at least one valid response, to provide reinforcing feedback to said user; and
instructions, to be executed responsive to said response not being one of said at least one valid response, to provide corrective feedback to said user.

14. A method for interacting with a user using an interactive doll, the interactive doll including a doll body having a plurality of decorative elements, the method comprising:
providing to the user an instruction from an instruction repository, via an output interface forming part of said interactive doll;
receiving from at least one sensor forming part of said doll, at least one transmission indicative of a response of the user to said instruction;
identifying, based on at least one transmission from at least one sensor forming part of said interactive doll, whether said response of the user to said instruction is a valid response to said instruction; and
based on said identifying, providing feedback to the user, via said at least out output interface.

14. (canceled)

15. The method of claim 13, wherein said providing feedback comprises, in response to said identifying that said response of the user is not a valid response to said instruction, providing a corrective feedback to the user.

16. The method of claim 13, wherein said providing feedback comprises, in response to said identifying that said response of the user is a valid response to said instruction, providing a reinforcing feedback to the user.
